(19) United States
(12) Patent Application Publication
(10) Pub. No.: US 2021/0394393 A1
(43) Pub. Date: Dec. 23, 2021

(54) REINFORCED CONCRETE MEMBER PRECAST YARD STRUCTURE

(71) Applicants: THE FOURTH ENGINEERING CO., LTD. OF CTCE GROUP, Anhui (CN); CHINA TIESIJU CIVIL ENGINEERING GROUP CO., LTD., Anhui (CN)

(72) Inventors: Xi YANG, Anhui (CN); Ping CHEN, Anhui (CN); He ZHANG, Anhui (CN); Jingxin HUANG, Anhui (CN); Zhigui LUO, Anhui (CN); Yi LANG, Anhui (CN)

(73) Assignees: THE FOURTH ENGINEERING CO., LTD. OF CTCE GROUP, Anhui (CN); CHINA TIESIJU CIVIL ENGINEERING GROUP CO., LTD., Anhui (CN)

(21) Appl. No.: 17/285,483

(22) PCT Filed: Oct. 13, 2020
(86) PCT No.: PCT/CN2020/120591

§ 371 Date: Apr. 15, 2021

(30) Foreign Application Priority Data
Oct. 23, 2019 (CN) 201911013331.8

(51) Int. Cl. B28B 15/00; B28B 11/24; B28B 23/22

(52) U.S. Cl. CPC B28B 15/00; B28B 23/22; B28B 11/245

(57) ABSTRACT

A reinforced concrete member precast yard structure including a precast and production workshop, a concrete mixing station, a curing and storage zone, an intelligent dispatching and control center, and water, electricity, and gas lines is provided. Automatic control equipment of each of the precast and production workshop, the concrete mixing station, and the curing and storage zone is connected to the intelligent dispatching and control center. Concrete in the concrete mixing station is transported to a corresponding production and precast zone through a plurality of concrete loading tracks. Reinforced concrete members produced in the precast and production workshop are transported to the curing and storage zone through transshipment equipment for curing and temporary storage. The precast and production workshop includes a rebar processing zone, a production, curing, and precast zone, and a pallet transshipment, production, and precast zone arranged in parallel with one another.

### BACKGROUND

### Technical Field

The disclosure relates to the construction field of reinforced concrete members, and in particular, relates to a reinforced concrete member precast yard structure.

### Description of Related Art

At present, a simply-set up color steel tile shed is used most of the time for establishment of a reinforced concrete member precast yard structure. Rebar processing is produced by semi-automatic equipment and is transported to the production zone manually or by a forklift. In the precast production, plastic mold+vibration table is adopted for vibrating and forming. forklifts are provided for reverse transportation, and precasted members are stored anywhere, are cured through manual watering, and are manually demolded, and the required concrete members are obtained. The types and quantities of the members are significant. In the production process, the number of inputted molds is huge, transportation and reverse transportation are frequently required, much space is needed for storage, and precast production and storage and shipping organizations are complicated. When the members are reverse-transported manually or through forklifts, the construction quality may not be suitable to be controlled, and damage occurs frequently in the process. Regarding the use of the simply-set up color steel tile shed, site planning may be considerably limited, operating standards are low, various processes are not well-connected, influences are generated greatly by human factors, and low production efficiency is presented. The storage space may occupy a large area and the members are stored separately, which greatly increases personnel input and difficulty of protection of the finished members. Further, since the production organizations are complicated, the problem of an increase in security risks emerges.

### SUMMARY

To solve the foregoing technical problems, the disclosure provides a reinforced concrete member precast yard structure including a precast and production workshop, a concrete mixing station, a curing and storage zone, an intelligent dispatching and control center, and water, electricity, and gas lines for overall arrangement, and through the structure, intelligent control is provided, intelligent transportation of components is achieved, precast efficiency is enhanced, and reinforced concrete members may not be easily damaged in a precast process.

The disclosure includes the following technical solutions.

A reinforced concrete member precast yard structure includes a precast and production workshop, a concrete mixing station, a curing and storage zone, an intelligent dispatching and control center, and water, electricity, and gas lines. The water, electricity, and gas lines are distributed in the precast and production workshop, the concrete mixing station, and the curing and storage zone. Automatic control equipment of each of the precast and production workshop, the concrete mixing station, and the curing and storage zone is connected to the intelligent dispatching and control center. Concrete in the concrete mixing station is transported to a corresponding production and precast zone through a plurality of concrete loading tracks. Reinforced concrete members produced in the precast and production workshop are transported to the curing and storage zone through transshipment equipment for curing and temporary storage.

The precast and production workshop includes a rebar processing zone and a plurality of production and precast zones arranged in parallel with each other. The rebar processing zone includes a raw material storage zone, a rebar unloading and production zone, a semi-finished product storage zone, and transportation channels arranged among the raw material storage zone, the rebar unloading and production zone, and the semi-finished product storage zone. The production and precast zones include a production, curing, and precast zone and a pallet transshipment, production, and precast zone.

The production, curing, and precast zone includes an even number of production conveyer tracks, a plurality of first formwork revolving tracks, and a plurality of vibration stations. The even number production conveyer tracks and the first formwork revolving tracks are parallel to each other. Front end portions of the first formwork revolving tracks are all filling stations, and right above the filling stations are the corresponding concrete loading tracks. Discharging outlets of concrete filling and unloading hoppers on the concrete loading tracks face the filling stations of the first formwork revolving tracks. Every two production conveyer tracks, one first formwork revolving track, and one vibration station are one group. Each of the first formwork revolving track is disposed between the corresponding two production conveyer tracks. One vibration station is located at a front end of the corresponding first formwork revolving track, that is, a side portion of the filling station. A formwork transshipment trolley is disposed between each of the vibration stations and the corresponding two production conveyer tracks. Each of the production conveyer tracks are provided with a molding station, a demolding station, a reinforced concrete member discharging station, and a formwork cleaning and assembly station in sequence from a front end to a back end. The formwork transshipment trolley is disposed between a back end of each of the first formwork revolving tracks and the corresponding two production conveyer tracks.

The pallet transshipment, production, and precast zone includes a second formwork revolving track, a formwork transshipment track, a turnover demolding spreader, a pallet transshipment track, a pallet revolving track, a curing station, and a discharging track. The second formwork revolving track is a U-shaped track, one end portion thereof is a filling vibration station, and right above the filling vibration station is the corresponding concrete loading track. The discharging outlet of the concrete filling and unloading hopper on the concrete loading track faces the filling vibration station, the other end portion of the second formwork revolving track is a mold reflowing station, and the mold reflowing station is provided with the turnover demolding spreader. The formwork transshipment track is disposed between the filling vibration station and the mold reflowing station of the second formwork revolving track. A front end of the pallet transshipment track is adjacent to the mold reflowing station such that the reinforced concrete members are overturned onto a pallet on the front end of the pallet transshipment track after the turnover demolding spreader is overturned. A back end of the pallet transshipment track is adjacent to the curing station, and an aerial hoisting truss is disposed at the curing station. A spreader on the aerial hoisting truss places the pallet with the reinforced concrete members on the pallet transshipment track to the curing station for curing. The discharging track is located at a discharging outlet of the curing station. A discharging transshipment trolley is disposed between the discharging outlet of the curing station and the discharging track. One end of the discharging track is the reinforced concrete member discharging station, and the other end of the discharging track is a pallet loading station. The pallet loading station of the discharging track faces a loading end of the pallet revolving track. An unloading end of the pallet revolving track is adjacent to the front end of the pallet transshipment track. A pallet transshipment trolley is disposed between the unloading end of the pallet revolving track and the front end of the pallet transshipment track.

The concrete mixing station includes a mixing plant, a bunker or a shed, and a storage tank. A mixer is installed in the mixing plant to mix concrete materials. A production capacity of the mixing plant is greater than an amount of concrete used in the precast and production workshop. The bunker is a fully enclosed or semi-enclosed shed for storing sand and gravel materials. A plurality of storage tanks are provided and are configured to store cement, fly ash, and additives. Feeding ends of the concrete loading tracks are all disposed right below an unloading opening of the mixing plant.

A reinforced concrete member storage pedestal is disposed in the curing station of the pallet transshipment, production, and precast zone. The spreader on the aerial hoisting truss places the pallet with the reinforced concrete members on the pallet transshipment track to the reinforced concrete member storage pedestal for curing.

A separate curing room is disposed in the production, curing, and precast zone, and a reinforced concrete member storage pedestal is disposed in the curing room.

The curing and storage zone includes a plurality of concrete strip-based storage pedestals, the storage pedestals are parallel to each other, and a transportation and storage road is arranged between adjacent storage pedestals. Magnetic navigation and landmark cards are arranged on the transportation and storage roads. Automatic transportation and storage equipment or a forklift transports reinforced concrete members or the reinforced concrete members on the pallet to the storage pedestals. The intelligent dispatching and control center controls the automatic transportation and storage equipment or the forklift to perform precise positioning according to the magnetic navigation and landmark cards, places the reinforced concrete members on the storage pedestals, and performs automatic spray curing on the reinforcement concrete members within a curing age. A finished product is shipped after the curing age reaches a designed standard.

The precast and production workshop, the concrete mixing station, and the curing and storage zone are all provided with mobile terminals and network communication stations. The automatic control equipment of all of the precast and production workshop, the concrete mixing station, and the curing and storage zone is connected to the corresponding mobile terminals and the network communication stations. The mobile terminals and the network communication stations of the precast and production workshop, the concrete mixing station, and the curing and storage zone are all connected to the intelligent dispatching and control center to achieve remote monitoring.

The water, electricity, and gas lines include electricity supply equipment and an electricity supply pipeline, water supply equipment and a water supply pipeline, and gas supply equipment and a gas supply pipeline. The electricity supply equipment, the water supply equipment, and the gas supply equipment are all connected to the intelligent dispatching and control center to achieve remote monitoring.

The disclosure includes the following advantages.

In the disclosure, the needs of rationalization, economy, and standardization of the precast yard production structure are satisfied, and the problem of construction quality control of reinforced concrete members is solved. An integrated production, curing, and transportation and storage system is achieved. Costs are effectively lowered, production efficiency is improved, and energy consumption is saved. Automated and mechanized operation methods are adopted, so that the production organizations of the precast yard are ensured to be reasonably and orderly planned. Less space is required to be occupied, process efficiency is enhanced, and labor and resource consumption are saved. Through the use of the intelligent dispatching and control center, factory-based and information-based production management mode is achieved, and construction speed, production efficiency, and construction quality are significantly improved. Therefore, labor and labor service inputs are reduced, and production costs are saved.

### BRIEF DESCRIPTION OF THE DRAWINGS

FIG. 1 is a distribution view of an overall structure according to the disclosure.

FIG. 2 is a schematic view of a structure of a production, curing, and precast zone according to the disclosure.

FIG. 3 is a schematic view of a structure of a pallet transshipment, production, and precast zone according to the disclosure.

FIG. 4 is a schematic view of a structure of a curing and storage zone according to the disclosure.

### DESCRIPTION OF THE EMBODIMENTS

Description will now be made in detail to clearly and completely present preferred embodiments of the disclosure, examples of which are illustrated in the accompanying drawings. Nevertheless, the disclosed embodiments are merely part of the embodiments of the disclosure, not all the embodiments. Based on the embodiments of the disclosure, all other embodiments obtained by a person of ordinary skill in the art without making any inventive effort fall within the scope that the disclosure seeks to protect.

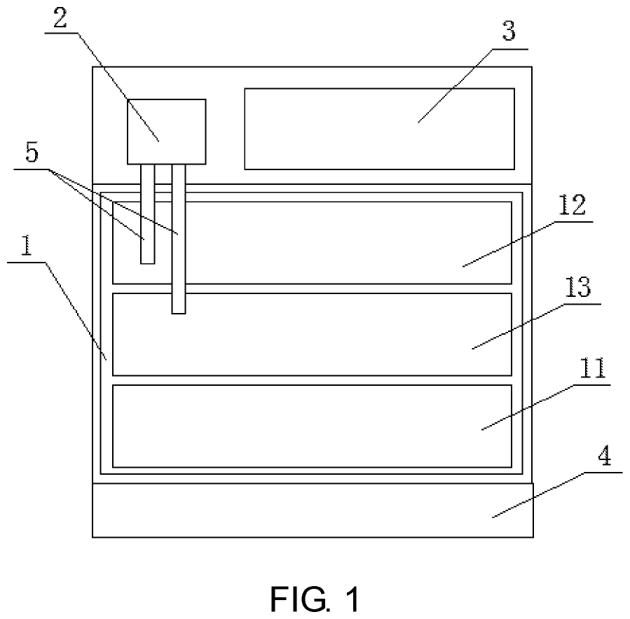

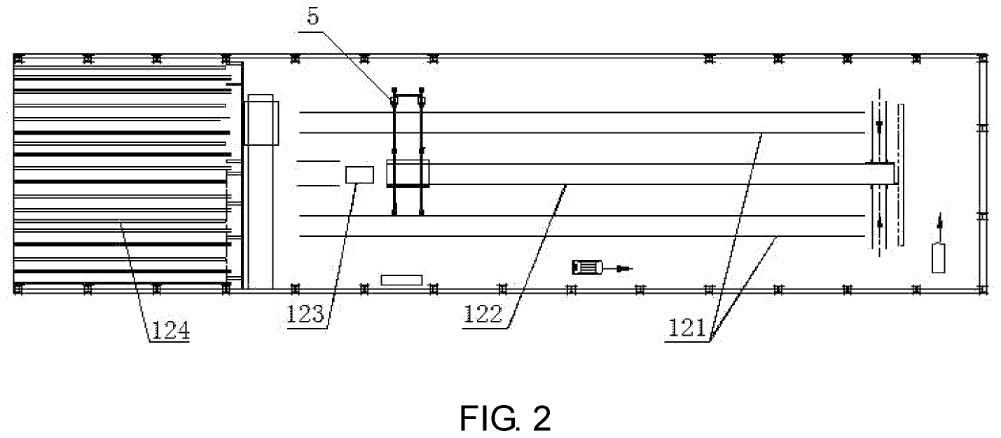

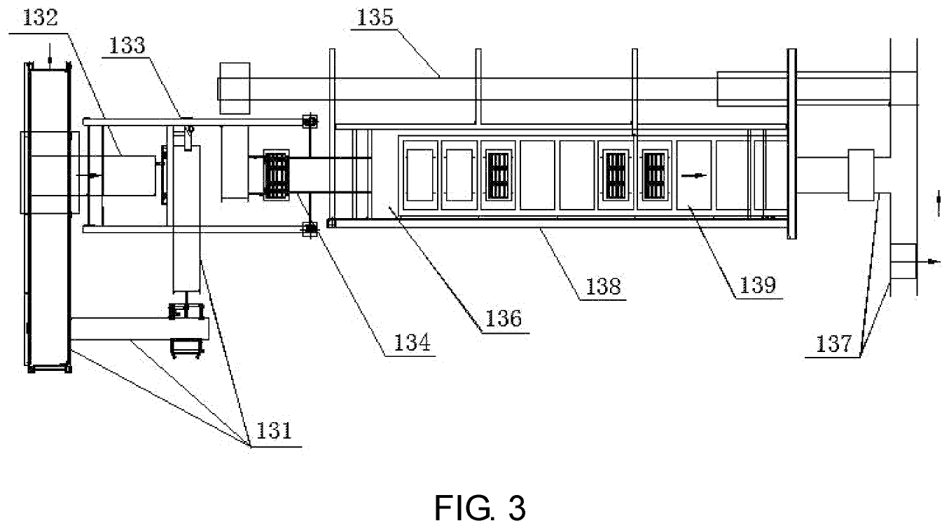

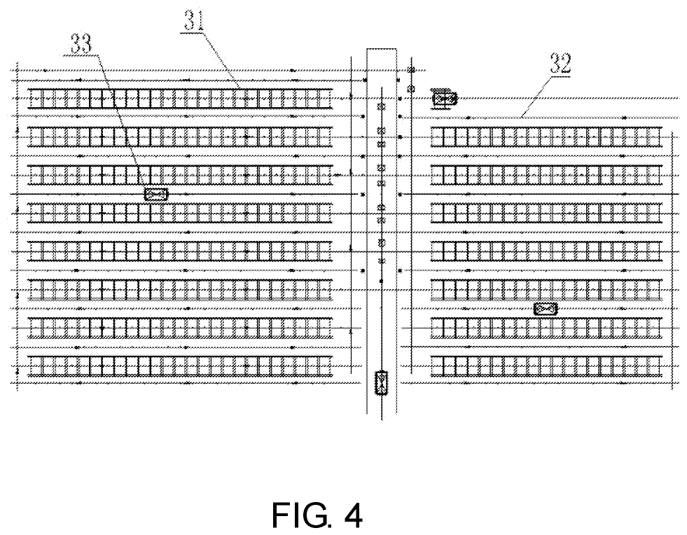

With reference to FIG. 1 to FIG. 4, a reinforced concrete member precast yard structure includes a precast and production workshop 1, a concrete mixing station 2, a curing and storage zone 3, an intelligent dispatching and control center 4, and water, electricity, and gas lines.

The precast and production workshop 1 includes a rebar processing zone 11, a production, curing, and precast zone 12, and a pallet transshipment, production, and precast zone 13 arranged in parallel with one another. The rebar processing zone 11 includes a raw material storage zone, a rebar unloading and production zone, a semi-finished product storage zone, and transportation channels arranged among the raw material storage zone, the rebar unloading and production zone, and the semi-finished product storage zone.

The concrete mixing station 2 includes a mixing plant, a bunker or a shed, and a storage tank. A mixer is installed in the mixing plant to mix concrete materials. A production capacity of the mixing plant is greater than an amount of concrete used in the precast and production workshop. The bunker is a fully enclosed or semi-enclosed shed for storing sand and gravel materials. A plurality of storage tanks are provided and are configured to store cement, fly ash, and additives. Concrete in the concrete mixing station 2 is transported to the production, curing, and precast zone 12 and the pallet transshipment, production, and precast zone 13 through a plurality of concrete loading tracks 5. Feeding ends of the concrete loading tracks 5 are all disposed right below an unloading opening of the mixing plant.

The production, curing, and precast zone 12 includes two production conveyer tracks 121, a first formwork revolving track 122, and a vibration station 123, and a separate curing room 124. The two production conveyer tracks 121 and the first formwork revolving track 121 are parallel to each other, and the first formwork revolving track 121 is disposed between the two production conveyer tracks 121. A front end portion of the first formwork revolving track 122 is a filling station, and right above the filling station is the corresponding concrete loading track 5. A discharging outlet of a concrete filling and unloading hopper on the concrete loading track 5 faces the filling station of the first formwork revolving track 122. The vibration station 123 is located at a front end of the first formwork revolving track 122, that is, a side portion of the filling station. A formwork transshipment trolley is disposed between the vibration station 123 and the corresponding two production conveyer tracks 121. Each of the production conveyer tracks 121 are provided with a molding station, a demolding station, a reinforced concrete member discharging station, and a formwork cleaning and assembly station in sequence from a front end to a back end. A formwork transshipment trolley is disposed between a back end of the first formwork revolving track 122 and the corresponding two production conveyer tracks 121. A reinforced concrete member storage pedestal is disposed in the curing room 124. Reinforced concrete members moved out from the reinforced concrete member discharging station are transported into the curing room 124 and are placed on the reinforced concrete member storage pedestal for curing.

The pallet transshipment, production, and precast zone 13 includes a second formwork revolving track 131, a formwork transshipment track 132, a turnover demolding spreader 133, a pallet transshipment track 134, a pallet revolving track 135, a curing station 136, and a discharging track 137. The second formwork revolving track 131 is a U-shaped track, one end portion thereof is a filling vibration station, and right above the filling vibration station is the corresponding concrete loading track. The discharging outlet of the concrete filling and unloading hopper on the concrete loading track faces the filling vibration station. The other end portion of the second formwork revolving track 131 is a mold reflowing station, and the mold reflowing station is provided with the turnover demolding spreader 133. The formwork transshipment track 132 is disposed between the filling vibration station and the mold reflowing station of the second formwork revolving track 131. A front end of the pallet transshipment track 132 is adjacent to the mold reflowing station such that the reinforced concrete members are overturned onto a pallet on the front end of the pallet transshipment track 134 after the turnover demolding spreader 133 is overturned. A back end of the pallet transshipment track 134 is adjacent to the curing station 136, and an aerial hoisting truss 138 is disposed at the curing station 136. A reinforced concrete member storage pedestal 139 is disposed in the curing station 136. A spreader on the aerial hoisting truss 138 places the pallet with the reinforced concrete members on the pallet transshipment track 134 to the reinforced concrete member storage pedestal 139 for curing. The discharging track 137 is located at a discharging outlet of the curing station 136, and a discharging transshipment trolley is disposed between the discharging outlet of the curing station 136 and the discharging track 137. One end of the discharging track 137 is the reinforced concrete member discharging station, and the other end of the discharging track 137 is a pallet loading station. The pallet loading station of the discharging track 137 faces a loading end of the pallet revolving track 135. An unloading end of the pallet revolving track 135 is adjacent to the front end of the pallet transshipment track 134, and a pallet transshipment trolley is disposed between the unloading end of the pallet revolving track 135 and the front end of the pallet transshipment track 134.

Reinforced concrete members produced in the precast and production workshop 1 are transported to the curing and storage zone 3 through transshipment equipment for curing and temporary storage. The curing and storage zone 3 includes a plurality of concrete strip-based storage pedestals 31. The storage pedestals 31 are parallel to each other, and a transportation and storage road 32 is arranged between adjacent storage pedestals 31. Magnetic navigation and landmark cards are arranged on the transportation and storage roads 32. Automatic transportation and storage equipment or a forklift 33 transports reinforced concrete members or the reinforced concrete members on the pallet to the storage pedestals 31. The intelligent dispatching and control center 4 controls the automatic transportation and storage equipment or the forklift 33 to perform precise positioning according to the magnetic navigation and landmark cards, places the reinforced concrete members on the storage pedestals 31, and performs automatic spray curing on the reinforcement concrete members within a curing age. A finished product is shipped after the curing age reaches a designed standard.

The water, electricity, and gas lines are distributed in the precast and production workshop 1, the concrete mixing station 2, and the curing and storage zone 3. The water, electricity, and gas lines include electricity supply equipment and an electricity supply pipeline, water supply equipment and a water supply pipeline, and gas supply equipment and a gas supply pipeline. The electricity supply equipment, the water supply equipment, and the gas supply equipment are all connected to the intelligent dispatching and control center 4 to achieve remote monitoring.

The precast and production workshop 1, the concrete mixing station 2, and the curing and storage zone 3 are provided with mobile terminals and network communication stations. The automatic control equipment of all of the precast and production workshop 1, the concrete mixing station 2, and the curing and storage zone 3 is connected to the corresponding mobile terminals and the network communication stations. The mobile terminals and the network communication stations of the precast and production workshop 1, the concrete mixing station 2, and the curing and storage zone 3 are all connected to the intelligent dispatching and control center 4 to achieve remote monitoring.

With reference to FIG. 1 to FIG. 4, a production process of reinforced concrete member precast includes the following steps.

(1) First, concrete mixed in the concrete mixing station 2 is transported to the production, curing, and precast zone 12 and the pallet transshipment, production, and precast zone 13 through the concrete loading tracks 5. Finished rebars and rebar cages processed in the rebar processing zone 11 are transported to the production, curing, and precast zone 12 and the pallet transshipment, production, and precast zone 13 through the transshipment equipment or the forklift.

(2) In the production, curing, and precast zone 12, concrete in the concrete filling and unloading hoppers on the concrete loading tracks 5 are filled into a formwork at the filling station of the first formwork revolving track 122. The concrete-filled formwork is transported to the vibration station 123 for vibrating, and the vibrated formwork is transported to the front end of any one of the production conveyer tracks 121 through the formwork transshipment trolley. Molding, demolding, reinforced concrete member discharging, formwork cleaning, release agent spraying, and modeling operations are performed on the formwork in sequence at the same time when the formwork are transported on the production conveyer track 121. After being discharged from the reinforced concrete member discharging station, the reinforced concrete members are transported to the curing room 124 through the transshipment equipment for curing. The formwork outputted by the production conveyer track 121 is transported to the back end of the first formwork revolving track 122 through the formwork transshipment trolley, and the formwork is transported from the back end to the front end of the first formwork revolving track 122 and is transported to the filling station for continued concrete filling.

(3) In the pallet transshipment, production, and precast zone 13, the concrete in the concrete filling and unloading hoppers on the concrete loading tracks 5 are filled into a formwork at the filling vibration station of the second formwork revolving track 131 and are vibrated. The filled formwork is transported to the mold reflowing station of the second formwork revolving track 131 through the formwork transshipment track 132. In the mold reflowing station, the reinforced concrete members in the formwork are overturned by the turnover demolding spreader 133 and are overturned onto the pallet on the front end of the pallet transshipment track 134. The formwork is transported from the mold reflowing station to the filling vibration station along the second formwork revolving track 131 for continued vibrating and filling. Cleaning, release agent spraying, and modeling operations are performed on the formwork when the formwork is transported on the second formwork revolving track 131. The spreader on the aerial hoisting truss 138 places the pallet with the reinforced concrete members on the pallet transshipment track 134 to the reinforced concrete member storage pedestal 139 for curing. After curing is completed, the reinforced concrete members are moved out of the pallet transshipment, production, and precast zone 13. The pallet is transported from the loading end to the unloading end of the pallet revolving track 135 and is then transported to the front end of the pallet transshipment track 134 through the pallet transshipment trolley for carrying the reinforced concrete members overturned by the turnover demolding spreader 133.

(4) The reinforced concrete members moved out from the production, curing, and precast zone 12 and the pallet transshipment, production, and precast zone 13 are transported to the curing and storage zone 3 through the transshipment equipment or the forklift for curing and temporary storage.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A reinforced concrete member precast yard structure, comprising: a precast and production workshop, a concrete mixing station, a curing and storage zone, an intelligent dispatching and control center, and water, electricity, and gas lines, wherein the water, electricity, and gas lines are distributed in the precast and production workshop, the concrete mixing station, and the curing and storage zone, automatic control equipment of each of the precast and production workshop, the concrete mixing station, and the curing and storage zone is connected to the intelligent dispatching and control center, concrete in the concrete mixing station is transported to a corresponding production and precast zone through a plurality of concrete loading tracks, and reinforced concrete members produced in the precast and production workshop are transported to the curing and storage zone through transshipment equipment for curing and temporary storage,
wherein the precast and production workshop comprises a rebar processing zone and a plurality of production and precast zones arranged in parallel with each other, the rebar processing zone comprises a raw material storage zone, a rebar unloading and production zone, a semi-finished product storage zone, and transportation channels arranged among the raw material storage zone, the rebar unloading and production zone, and the semi-finished product storage zone, and the production and precast zones comprise a production, curing, and precast zone and a pallet transshipment, production, and precast zone,
wherein the production, curing, and precast zone comprises an even number of production conveyer tracks, a plurality of first formwork revolving tracks, and a plurality of vibration stations, the even number production conveyer tracks and the first formwork revolving tracks are parallel to each other, front end portions of the first formwork revolving tracks are all filling stations, right above the filling stations are the corresponding concrete loading tracks, discharging outlets of concrete filling and unloading hoppers on the concrete loading tracks face the filling stations of the first formwork revolving tracks, every two production conveyer tracks, one first formwork revolving track, and one vibration station are one group, each of the first formwork revolving track is disposed between the corresponding two production conveyer tracks, one vibration station is located at a front end of the corresponding first formwork revolving track, that is, a side portion of the filling station, a formwork transshipment trolley is disposed between each of the vibration stations and the corresponding two production conveyer tracks, each of the production conveyer tracks is provided with a molding station, a demolding station, a reinforced concrete member discharging station, and a formwork cleaning and assembly station in sequence from a front end to a back end, and a formwork transshipment trolley is disposed between a back end of each of the first formwork revolving tracks and the corresponding two production conveyer tracks,
wherein the pallet transshipment, production, and precast zone comprises a second formwork revolving track, a formwork transshipment track, a turnover demolding spreader, a pallet transshipment track, a pallet revolving track, a curing station, and a discharging track, the second formwork revolving track is a U-shaped track, one end portion thereof is a filling vibration station, right above the filling vibration station is the corresponding concrete loading track, the discharging outlet of the concrete filling and unloading hopper on the concrete loading track faces the filling vibration station, the other end portion of the second formwork revolving track is a mold reflowing station, the mold reflowing station is provided with the turnover demolding spreader, the formwork transshipment track is disposed between the filling vibration station and the mold reflowing station of the second formwork revolving track, a front end of the pallet transshipment track is adjacent to the mold reflowing station such that the reinforced concrete members are overturned onto a pallet on the front end of the pallet transshipment track after the turnover demolding spreader is overturned, a back end of the pallet transshipment track is adjacent to the curing station, an aerial hoisting truss is disposed at the curing station, a spreader on the aerial hoisting truss places the pallet with the reinforced concrete members on the pallet transshipment track to the curing station for curing, the discharging track is located at a discharging outlet of the curing station, a discharging transshipment trolley is disposed between the discharging outlet of the curing station and the discharging track, one end of the discharging track is the reinforced concrete member discharging station, the other end of the discharging track is a pallet loading station, the pallet loading station of the discharging track faces a loading end of the pallet revolving track, an unloading end of the pallet revolving track is adjacent to the front end of the pallet transshipment track, and a pallet transshipment trolley is disposed between the unloading end of the pallet revolving track and the front end of the pallet transshipment track.

2. The reinforced concrete member precast yard structure according to claim 1, wherein the concrete mixing station comprises a mixing plant, a bunker, and a storage tank, a mixer is installed in the mixing plant to mix concrete materials, a production capacity of the mixing plant is greater than an amount of concrete used in the precast and production workshop, the bunker is a fully enclosed or semi-enclosed shed for storing sand and gravel materials, a plurality of storage tanks are provided and are configured to store cement, fly ash, and additives, and feeding ends of the concrete loading tracks are all disposed right below an unloading opening of the mixing plant.

3. The reinforced concrete member precast yard structure according to claim 1, wherein a reinforced concrete member storage pedestal is disposed in the curing station of the pallet transshipment, production, and precast zone, and the spreader on the aerial hoisting truss places the pallet with the reinforced concrete members on the pallet transshipment track to the reinforced concrete member storage pedestal for curing.

4. The reinforced concrete member precast yard structure according to claim 1, wherein a separate curing room is disposed in the production, curing, and precast zone, and a reinforced concrete member storage pedestal is disposed in the curing room.

5. The reinforced concrete member precast yard structure according to claim 1, wherein the curing and storage zone comprises a plurality of concrete strip-based storage pedestals, the storage pedestals are parallel to each other, a transportation and storage road is arranged between adjacent storage pedestals, magnetic navigation and landmark cards are arranged on the transportation and storage roads, automatic transportation and storage equipment or a forklift transports reinforced concrete members or the reinforced concrete members on the pallet to the storage pedestals, the intelligent dispatching and control center controls the automatic transportation and storage equipment or the forklift to perform precise positioning according to the magnetic navigation and landmark cards, places the reinforced concrete members on the storage pedestals, and performs automatic spray curing on the reinforcement concrete members within a curing age, and a finished product is shipped after the curing age reaches a designed standard.

6. The reinforced concrete member precast yard structure according to claim 1, wherein the precast and production workshop, the concrete mixing station, and the curing and storage zone are all provided with mobile terminals and network communication stations, the automatic control equipment of all of the precast and production workshop, the concrete mixing station, and the curing and storage zone is connected to the corresponding mobile terminals and the network communication stations, and the mobile terminals and the network communication stations of the precast and production workshop, the concrete mixing station, and the curing and storage zone are all connected to the intelligent dispatching and control center to achieve remote monitoring.

7. The reinforced concrete member precast yard structure according to claim 1, wherein the water, electricity, and gas lines comprise electricity supply equipment and an electricity supply pipeline, water supply equipment and a water supply pipeline, and gas supply equipment and a gas supply pipeline, and the electricity supply equipment, the water supply equipment, and the gas supply equipment are all connected to the intelligent dispatching and control center to achieve remote monitoring.
